(19) United States
(12) Patent Application Publication
(10) Pub. No.: US 2010/0159992 A1
(43) Pub. Date: Jun. 24, 2010

(54) MOBILE COMMUNICATION DEVICE WITH A SLIDING DISPLAY SCREEN AND SCREEN-DIVIDING MEMBER

(75) Inventor: Panu Marten Jesper Johansson, Tampere (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/337,867

(22) Filed: Dec. 18, 2008

(51) Int. Cl. H04M 1/02

(52) U.S. Cl. 455/566; 455/575.4

(57) ABSTRACT

A mobile communications device includes a slidable display screen positioned on top of a keypad. The display screen is slidable between a first position and a second position. The display screen covers the keypad when the display screen is in the first position. The keypad is exposed when the display screen is in the second position. The device includes a screen-dividing member extending over the slidable display screen. The display screen slides underneath the screen-dividing member. The screen-dividing member includes at least one input control for navigating within a user interface presented on the display screen.

### BACKGROUND

As the technology surrounding mobile communication devices advances, mobile communication devices are including more features. For example, mobile communication devices frequently include features such as email, internet capability, and games. Although the number of features on mobile communication devices continues to increase, there is still a desire for such devices to remain as compact as possible. With the inclusion of numerous features on mobile communication devices, manufacturers often try to maximize display area to allow a user to effectively utilize features of the device. One way of maximizing display area while maintaining a usable keypad in a mobile communications device is to employ a sliding display screen. Even with sliding display screens, however, there remains a need for improved manners of displaying user interfaces on mobile communications devices and improved ways of receiving input data in response to such displays.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In at least some embodiments a mobile communication device includes a slidable display screen and a screen-dividing member. The mobile communication device includes a housing encompassing a keypad. A display screen is slidably mounted to the housing over the keypad and is movable between a first position and a second position. When the display screen is in the first position the display screen covers at least a portion of the keypad. When the display screen is in the second position, the keypad and a plurality of keys are exposed. The screen-dividing member is attached to the housing and extends across the display screen, such that the display screen slides between the screen-dividing member and the housing. The screen-dividing member includes at least one user-operable input control for navigating through user interfaces displayed on the display screen. The mobile communications device may receive input from the keypad when the display screen is in the second position exposing the keypad.

Further embodiments relate to methods for operating a mobile communications device having a slidable display screen and a screen-dividing member with at least one user-operable input control for navigating through a user interface displayed on the display screen. The method includes receiving a first signal corresponding to a first position of the display screen. In response to the first signal, a plurality of images is displayed on the display screen. A first image is positioned on a first portion of the display screen and a second image is displayed on a second portion of the display screen. A second signal corresponding to a second position of the display screen is received. In response to the second signal, a single image occupying substantially all of the display screen is displayed on the display screen.

Further embodiments relate to an apparatus comprising a processor and a machine-readable medium storing machine-executable instructions for receiving a first signal corresponding to a first position of the display screen. In response to the first signal, the processor displays a plurality of images on the display screen such that a first image is positioned on a first portion of the display screen and a second image is displayed on a second portion of the display screen. The processor receives a second signal corresponding to a second position of the display screen. In response to the second signal, the processor displays a single image occupying substantially all of the display screen.

### BRIEF DESCRIPTION OF THE DRAWINGS

FIG. 1 is a block diagram of components of a mobile communications device according to some embodiments.

FIG. 2A is a side view of a mobile communication device, according to some embodiments, with a display screen in a first position.

FIG. 2B is a front view of the mobile communication device shown in FIG. 2A.

FIG. 3A is a side view of the mobile communications device of FIGS. 2A and 2B, with the display screen in a second position.

FIG. 3B is a front view of the mobile communications device shown in FIG. 3A.

FIG. 4 is a front view of a mobile communications device according to another embodiment.

FIGS. 5A-5D show examples of images presented on the display screen of the mobile communications device of FIGS. 1-3B.

FIG. 6 illustrates operations performed by the processor in the mobile communications devices of FIGS. 1-5D.

### DETAILED DESCRIPTION

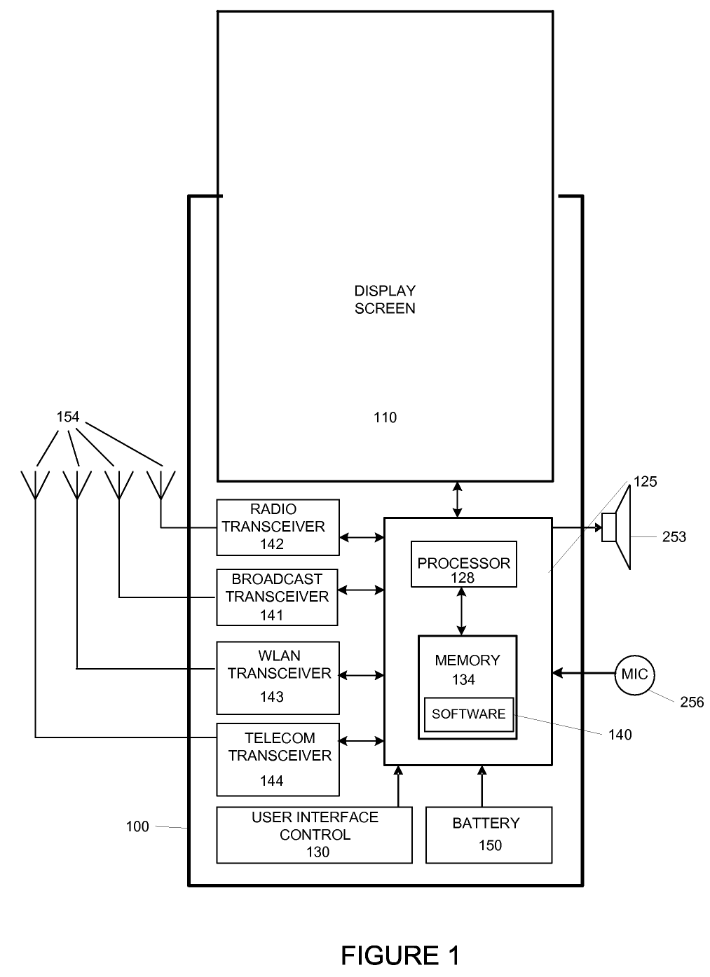

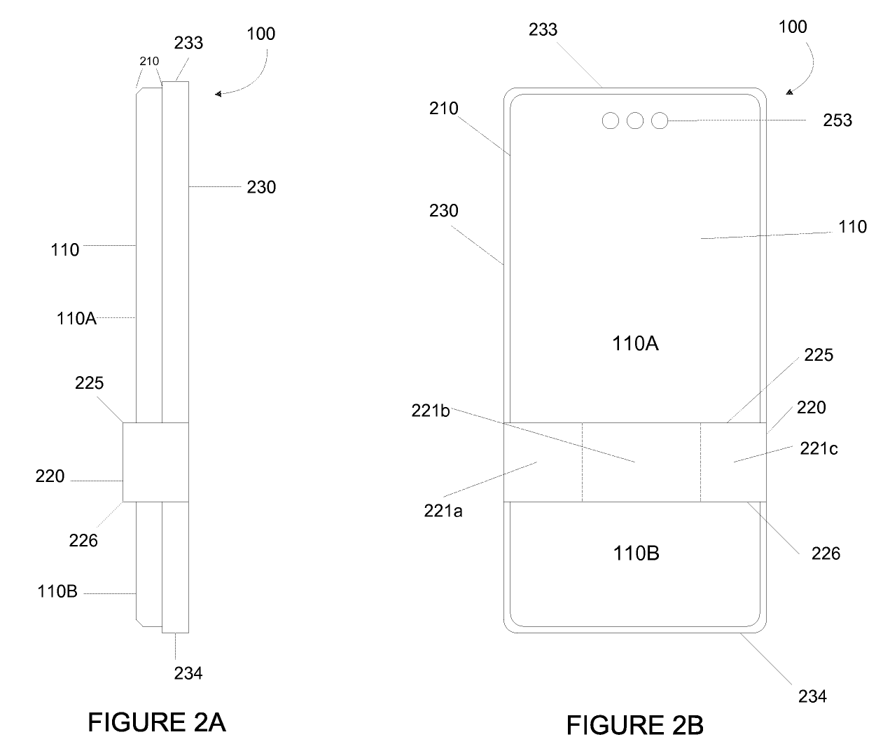

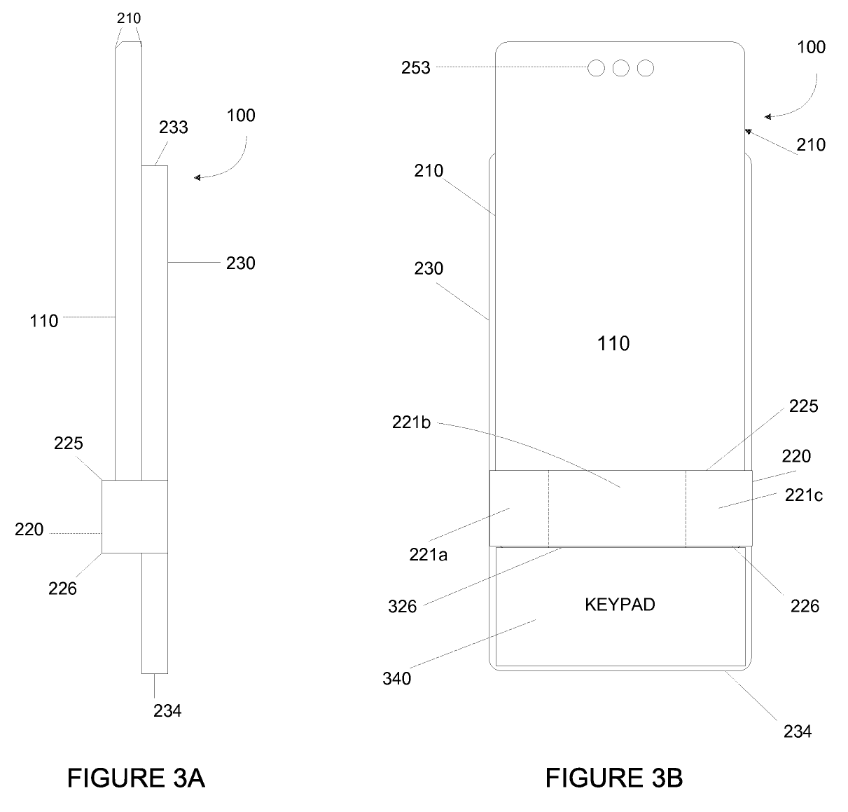

FIG. 1 is a block diagram of a mobile communications device 100 according to at least some embodiments. Mobile communications device 100 may be used in one or more wireless networks, as discussed below. In at least one embodiment, mobile communications device 100 includes a controller 125 connected to a user interface control 130, display screen 110, and other elements as illustrated. Controller 125 includes one or more processors 128 and memory 134 storing software 140. Mobile communications device 100 includes a battery 150, speaker 253 and antenna(s) 154. User interface control 130 includes controllers and/or adapters configured to receive input from user-operable input controls such as buttons, capacitive-sensing inputs, or other input controls located in regions 221a-c (described below in connection with FIGS. 2A-3B) and keypad 340 (described in connection with FIG. 3B) and provides signals to processor 128 based on user input.

Computer executable instructions and data used by processor 128 and other components of mobile communications device 100 may be stored in a storage facility such as memory 134. Memory 134 may comprise any type or combination of read only memory (ROM) modules or random access memory (RAM) modules, including both volatile and nonvolatile memory such as disks. Software 140 is stored within memory 134 to provide instructions to processor 128 such that when the instructions are executed, processor 128, mobile communications device 100 and/or other components of mobile communications device 100 are caused to perform various functions or methods such as those described herein. Software may include both applications and operating system software, and may include code segments, instructions, applets, pre-compiled code, compiled code, computer programs, program modules, engines, program logic, and combinations thereof. Computer executable instructions and data may further be stored on computer readable media including EEPROM, flash memory or other memory technology, CD-ROM, DVD or other optical disk storage, magnetic cassettes, magnetic tape, magnetic storage and the like.

It should be understood that various method steps, procedures or functions described herein may be implemented using one or more processors in combination with executable instructions that cause the processors and other components to perform the method steps, procedures or functions. As used herein, the terms “processor” and “computer” whether used alone or in combination with executable instructions stored in a memory or other computer-readable storage medium should be understood to encompass any of various types of well-known computing structures including but not limited to one or more microprocessors, special-purpose computer chips, field-programmable gate arrays (FPGAS), controllers, application-specific integrated circuits (ASICS), combinations of hardware/firmware, or other special or general-purpose processing circuitry.

Mobile communications device 100 and/or its various components may be configured to receive, decode and process various types of transmissions including digital broadband broadcast transmissions that are based, for example, on the Digital Video Broadcast (DVB) standard, such as DVB-H, DVB-H+, or DVB-MHP, through a specific broadcast receiver 141. Other digital transmission formats may alternatively be used to deliver content and information of availability of supplemental services. Additionally or alternatively, mobile communications device 100 may be configured to receive, decode and process transmissions through FM/AM radio receiver 142, wireless local area network (WLAN) transceiver 143, and telecommunications transceiver 144. Transceivers 143 and 144 may, alternatively, include individual transmitter and receiver components.

FIG. 2A is a side view of mobile communications device 100. FIG. 2B is a front view of the mobile communications device 100. As shown in FIG. 2B, the mobile communications device 100 includes a housing 230. The housing 230 may be any suitable type of housing for encompassing the electronic and mechanical parts of the mobile communications device 100. For example, the housing 230 may be plastic or metal and in a generally rectangular shape. The housing 230 holds components such as the keypad 340 discussed below in connection with FIG. 3B, the processor 128, the battery 150, the microphone 256, and the speaker 253, as well as other components described in FIG. 1. The housing 230 includes a first end 233 and a second end 234.

The mobile communications device 100 also includes a slidable display screen assembly 210. The display screen assembly 210 includes display 110 (FIG. 1) mounted onto a slidable cover. The display screen 110 may be any suitable type of display for a mobile communications device 100, and has an outer face for displaying images. For example, the display screen 110 may include a LCD screen. Alternatively, the display screen assembly 210 may be a touch screen. The display screen assembly 210 is slidably attached to the housing 230 in any suitable manner that allows the display screen assembly 210 to slide between a first position and a second position. In one embodiment, for example, the display screen assembly 210 may include rails that attach to and slide within corresponding rails on the housing 230, with electrical communication between the display screen 110 and other device electronics carried via one or more ribbon cables (not shown) located between the display screen assembly 210 and the housing 230.

In the embodiment of FIGS. 2A and 2B, display screen assembly 210 can be placed into a first position in which the display screen 210 is generally flush with the housing 230 at the first end 233 and at the second end 234. Display screen assembly 210 can also be placed in a second position in which the display screen 110 extends above the first end 233 of the housing 230, as illustrated in FIGS. 3A and 3B. Referring back to FIGS. 2A and 2B, the display screen assembly 210 may be moved between the first position and the second position in any suitable manner. For example, a user may push on a portion of the display screen assembly 210 to slide it between positions. Alternatively, a user may push a button or other mechanical release that facilitates movement of the display screen assembly 210 between the first and second positions. The mobile communications device 100 includes a contact (not shown) that detects the position of the display screen assembly 210 and sends a signal to the processor 128.

FIG. 3A is a side view of mobile communications device 100, with the display screen assembly 210 in the second position. FIG. 3B is a front view of the mobile communications device 100 with the display screen assembly 210 in the second position. The mobile communication device 100 also includes a keypad 340, as shown in FIG. 3B, for text entry, e.g. in response to a user interface presented in an image on the display screen 110 or for performing functions or actions in connection with a user interface. The keypad 340 is positioned within the housing 230, proximate the second end 234. The keypad 340 may be mounted to the housing 230 in any suitable manner for keeping the keypad 340 stationary within the housing 230. The keypad 340 includes a plurality of keys. In different embodiments, the number of keys may vary. For example, the keypad 340 may include twelve keys corresponding to the numbers 0-9 and the “*” and “#” keys. As another example, the keypad 340 could in some embodiments include a full QWERTY miniature keyboard with keys corresponding to all of the letters in the alphabet and commonly used symbols such as “%” and “&”. The keypad 340 may also include function keys such as an “Enter” key or a “Shift” key.

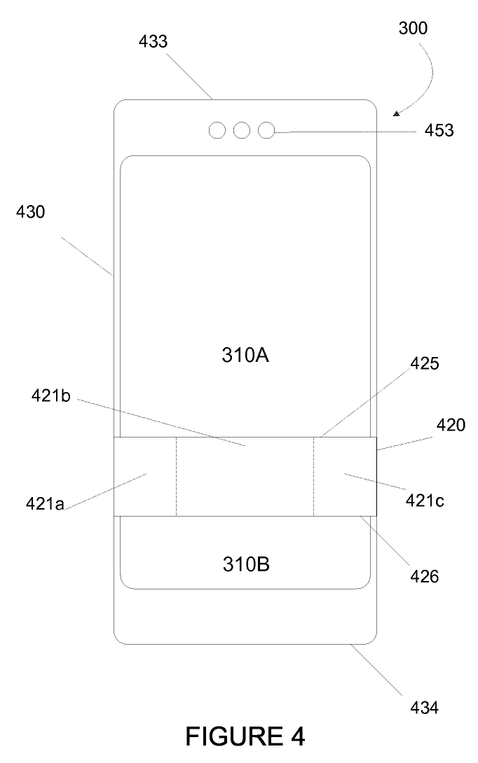

In at least one embodiment of the invention, as illustrated in FIGS. 2A and 2B, the display screen assembly 210 is slidably positioned on top of the keypad 340. When the display screen assembly 210 is in the first position, the display screen assembly 210 covers at least a portion of the keypad 340. In at least some embodiments, the display screen assembly 210 covers the entire keypad 340, when the display screen assembly 210 is in the first position. Alternatively, as illustrated in FIG. 3B, when the display screen assembly 210 is in the second position, all of the keys on the keypad 340 are exposed and a user may operate the keypad 340. In one embodiment, as shown in FIG. 2B, the display screen assembly 210 covers the entire length of the mobile communications device 100, when the display screen assembly 210 is in the first position. In an alternative embodiment, as discussed below in connection with FIG. 4, a display screen assembly 410 covers only a portion of a mobile communications device 300, when the display screen assembly 410 is in the first position, and a housing 420 surrounds the display screen 410.

Referring back to FIGS. 2A and 2B, the mobile communications device 100 includes a screen-dividing member 220. The screen-dividing member 220 may be attached to the housing 230 in any suitable way. For example, the screen-dividing member 220 may be formed as a unitary piece with the housing 230 or may be press-fit to the housing 230. The screen-dividing member 220 is positioned across and above the display screen assembly 210, such that the display screen assembly 210 slides between the screen-dividing member 220 and the housing 230 when the display screen assembly 210 moves between the first and second positions. In at least one embodiment, the screen-dividing member 220 extends horizontally across the display screen 110, when the mobile communications device 100 is in a vertical position, as illustrated in FIG. 2B. In at least one exemplary embodiment, the screen-dividing member 220 remains stationary with respect to the housing 230. The screen-dividing member 220 may be positioned at any suitable position along the housing 230. For example, the screen-dividing member 220 may be positioned closer to the first end 234 of the housing 230 to accommodate a larger keypad 340, or positioned closer to the second end 234 of the housing 230 to accommodate a smaller keypad 340. In an exemplary embodiment, the screen-dividing member 220 is positioned adjacent the keypad 340, as shown in FIG. 3B. The screen-dividing member 220 includes a first edge 226 and a second edge 225. In the embodiment of FIGS. 1-3B, the first edge 226 is adjacent the outer edge 326 of the keypad 340.

Referring back to FIGS. 2A and 2B, the screen-dividing member 220 includes at least one user-operable input control that allows a user to navigate through user interfaces displayed on the display screen 110. As used herein, input control includes buttons, capacitive sensors, membrane switches and other devices configured to detect movement of (or contact by) a user's digit and convert that movement (or contact) into an electrical signal. For example, the screen-dividing member 220 may include a single input control (not shown) or a plurality of input controls in any of regions 221a-c. In at least one exemplary embodiment, the screen-dividing member 220 includes three input controls, one in each of regions 221a-c. In some embodiments, the input control in region 221b controls a cursor moveable through menus on a graphical and/or textual user interface presented on a portion of display screen 110, and may also permit a user to perform an action or operation (e.g., selecting a menu item) within the user interface. In this embodiment, the input control in region 221b may navigate through the menus in a direction corresponding to a portion of the input control in region 221b touched by a user. For example, the cursor may move in an upward direction when an upper portion of input control in region 221b is pressed or touched. The input controls in regions 221a and 221c may, e.g., act as soft keys usable to select menu items corresponding to elements displayed on the display screen 110 in locations above those input controls.

The input controls in regions 221a-c may perform different functions depending on the mode in which the mobile communications device 100 is placed. For example, the input controls in regions 221a-c may allow the user to answer or end a call if the mobile communications device 100 is in a telephone mode, or may allow a user to send or view a text or e-mail message if in a messaging mode, etc. The input controls in regions 221a-c on the screen-dividing member 220 may be any suitable type of input controls that allow interaction with the mobile communications device 100. In at least one embodiment, the input controls in regions 221a-c are capacitive buttons. The screen-dividing member 220 may be made out of any suitable material for extending across the display screen 210 and housing input controls. In an exemplary embodiment, the screen-dividing member 220 is made out of transparent material allowing images displayed on the display screen 110 to show through the screen-dividing member 220. For example, an image, such as an icon may display through the screen-dividing member 220. In this example, a user may press or touch a capacitive or other touch-sensitive region on the screen-dividing member above the icon to initiate an application associated with the icon on the display screen 110.

When the display screen assembly 210 is in the first position (FIGS. 2A and 2B), input to the user interface on the display screen 110 is only received from the input controls in regions 221a-c on the screen-dividing member 220. Alternatively, when the display screen assembly 210 is in the second position and the keypad 340 and its keys are exposed (FIGS. 3A-3B), a user may provide input to the mobile communications device 100 through both the keypad 340 and the input controls in regions 221a-c on the screen-dividing member 220.

In at least one embodiment, the screen-dividing member 220 is removable from the mobile communications device 100. For example, when the display screen assembly 210 is in the second position, a user may remove the screen-dividing member 220 and utilize the keypad 340 for inputting information into the mobile communications device 100. The user may then replace the screen-dividing member 220 and may then provide input to the mobile communications device 100 through the screen-dividing member 200.

In some embodiments a screen-dividing member similar to screen-dividing member 220 slides along at least a portion of the housing. In one such embodiment, the screen-dividing member slides between a first end and a second end of the housing. In an alternate embodiment, the screen-dividing member slides between an outer edge of the keypad and the first end of the housing.

When the display screen assembly 210 is in the first position, a first portion 110B of the display screen 110 is located between the first edge 226 of the screen-dividing member 220 and the housing second end 234, as illustrated in FIG. 2B. A second portion 110A of the display screen 110 is located between the second edge 225 of the screen-dividing member 220 and the housing first end 233. In at least one embodiment, the processor 128 is configured to display a first image on the first portion 110B of the display screen 110 and a second image on the second portion 110A of the display screen 110, based on the display screen assembly 210 being in the first position.

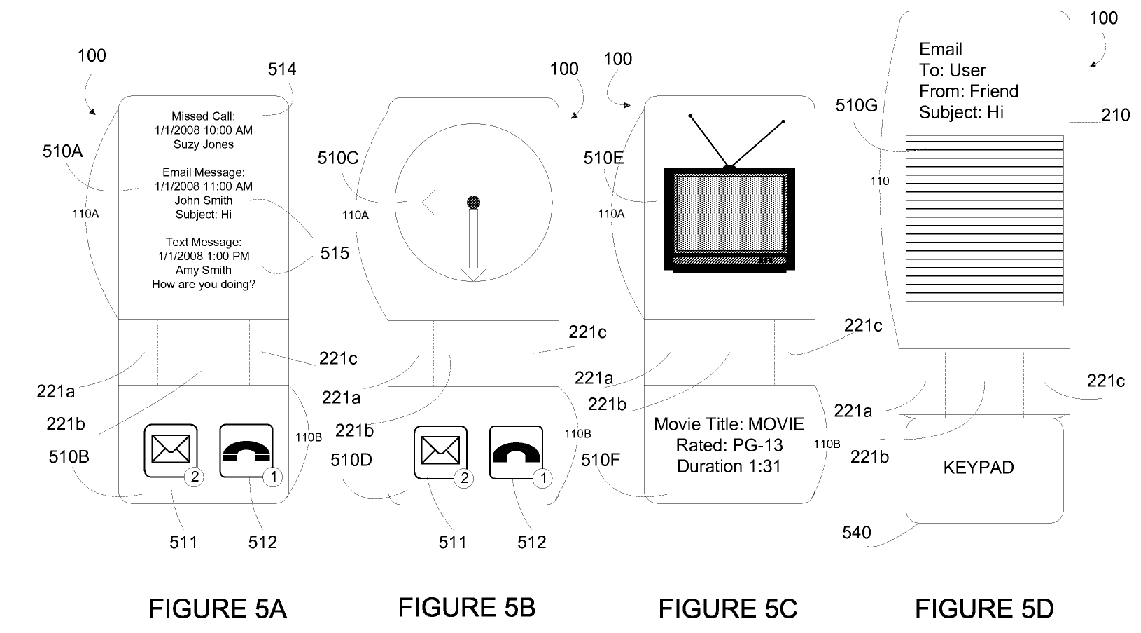

As illustrated in FIG. 5D, the processor 128 is configured to display a single image on the display screen 110, when the display screen assembly 210 is in the second position. When the display screen assembly 210 is in the second position, the image may occupy substantially the entire portion of the display screen 110. Alternatively, as shown in FIGS. 5A-5C, the processor 128 is configured to display a plurality of images on the display screen 110 when the display screen assembly 210 is in the first position. Numerous types and arrangements of images can be presented on display screen 110. In one scenario, for example, and as illustrated in FIG. 5A, the first display screen portion 110B may show an image (or images) 510B providing notifications such as a missed call 512 or a new message 511. The new message 511 may include an e-mail message or a text message. The second display screen portion 110A may show an image (or images) 510A providing details about the new messages 515 or the missed call 514 indicated in the first display screen portion 110B.

In at least one embodiment, the processor 128 is configured, when the display screen assembly 210 is in the first position, to display a first image on the first display screen portion 110B, that provides selectable options for a user to choose the image displayed on the second display screen portion 110A. If the mobile communications device 100 is idle, the display screen 110 may be blank or may display a screen saver. For example, the first display screen portion 110A may show an image of a clock 510C, as shown in FIG. 5B.

FIG. 5C is another example of images shown on the first portion 110A and second portion 110B when the display screen assembly 210 is in the first position. In the example of FIG. 5C, the second display screen portion 110A may show a movie 510E, while the first display screen portion 110B shows details 510F about the movie 510E, such as the title, the rating and the duration.

In another example illustrated in FIG. 5D, if the display screen assembly 210 is in the second position, the processor 128 displays a single image on the display screen 110. In this example, the display screen 110 may show any applicable images or user interfaces for a mobile communications device 100, such as the text of an email 510G, illustrated in FIG. 5D. Other images displayed on display screen 110 may be mobile telephone menu, a movie or a file that the user opens.

FIG. 4 is a front view of an alternative embodiment of a mobile communications device 300. Elements of FIG. 4 correspond to elements illustrated in FIGS. 1-3B, having similar numbers offset by 200. For example, the display screen assembly 210 in FIGS. 2A-3B is assigned reference number 410 in FIG. 4. In the embodiment shown in FIG. 4, the housing 430 extends from the back of the mobile communications device 300 over the first end 433 and the second end 434 to encompass the display screen assembly 410. As compared to the embodiment shown in FIGS. 2A through 3B, the display screen assembly 410 extends over less of the mobile communications device 300. Accordingly, the size of the second display portion 310A and first display portion 310B may be smaller than those depicted in FIG. 2B. In the embodiment illustrated in FIG. 4, a speaker 453 may be incorporated into a front side of the housing 430. The mobile communications device 100 may include a microphone at any suitable place within the housing 430. The embodiment of FIG. 4 includes components similar to those described in connection with FIG. 1 and operates in a manner similar to that of the embodiments of FIGS. 1-3B, but with the displays adjusted to account for reduced screen area.

One of ordinary skill in the art will appreciate that the components depicted in FIGS. 1-5 are connected to each other by electrical connections. The mobile communications device 100 (or 300) may include additional parts for functioning as a mobile communications device. For example, the mobile communications device 100 may also include a camera for taking pictures. The mobile communications device 100 may include additional input controls such as a power input control and a volume control input control. In at least one embodiment, the mobile communications device 100 is a mobile telephone for making and receiving telephone calls. The mobile communications device 100 may include numerous features. For example, the mobile communications device 100 may be capable of sending and receiving voice calls, sending text or SMS messages, sending data including pictures or files, and playing multi-media files. The mobile communications device 100 may also include the features of a personal digital assistant (PDA).

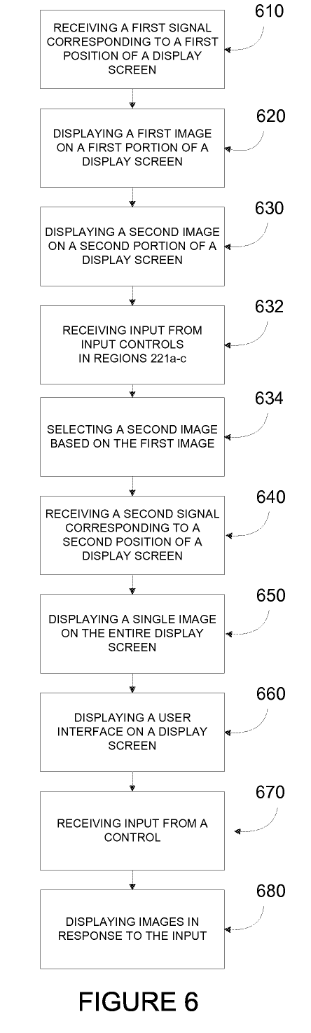

Other aspects include method steps performed by the processor 128 and correspond to executable instructions stored on a machine-readable medium such as the memory 134 of the processor 128. One example of such method steps is depicted in FIG. 6. In step 610, a signal corresponding to the first position of the display screen assembly 210 is detected. In the first position, the display screen assembly 210 covers at least a portion of a plurality of the keys of keypad 340. In step 620, in response to the received first signal, a first image is displayed on a first portion 110B of the display screen 110. For example, as illustrated in FIG. 5A, images showing notifications of missed calls and emails may be shown in the first portion 110B of the display screen 110. A second image is displayed on a second portion 110A of the display screen 110, as illustrated in step 630. For example, in FIG. 5A, the details of the notifications shown in the first portion 110B are shown in 110A. In step 632, input from one or more of the input controls in regions 221a-c is received by the processor 128, when the display screen assembly 210 is in the first position. In at least one embodiment, the image on the first portion 110B of the display screen 110 includes selectable options allowing a user to choose the second image displayed on the second portion 110A of the display screen 110; such selection is illustrated in step 634.

In step 640, a second signal corresponding to a second position of the display screen assembly 210 is received. In the second position, the display screen assembly 210 exposes a plurality of keys on the keypad 340. In response to the second signal, a single image is displayed on the entire display screen 110, in step 650. The single image occupies substantially the entire display screen 110. One example of a single display image is illustrated in FIG. 5D, illustrating an email displayed on substantially the entire display screen 110. In step 660, a user interface is displayed on the display screen 110. Alternatively, the imaged displayed in step 650 could be a user interface and step 660 omitted. In step 670, input is received from an input control in one of regions 221a-c of the screen-dividing member 220 and/or the keypad 340, in response to the user interface displayed in step 660. In step 680, images are displayed on the display screen 110 in response to the input in step 670.

Persons of skill in the art will, after reading the description herein and the accompanying drawings, appreciate various advantages of one or more embodiments. For example, in the embodiment of FIGS. 1-3B, mobile communications device 100 need not have a touch sensitive display screen so as to permit a user to navigate the images when the keypad is covered. A further advantage to the mobile communications device 100 as described is that the screen-dividing member 220 provides a natural physical demarcation between separate images.

In alternate embodiments, the screen-dividing member 220 can have different widths or other physical shapes. For example, the screen-diving member 220 may not extend all the way across the display screen 110. In other examples, the screen-dividing member 220 may not have a constant width or may be curved, etc.

Although examples of carrying out the invention have been described, those skilled in the art will appreciate that there are numerous other variations, combinations and permutations of the above described devices and techniques that fall within the spirit and scope of the invention as set forth in the appended claims. The above description and drawings are illustrative only. The invention is not limited to the illustrated embodiments, and all embodiments of the invention need not necessarily achieve all of the advantages or purposes, or possess all characteristics, identified herein.

We claim:

1. An apparatus comprising:
a housing having a first end and a second end;
a keypad mounted within the housing proximate to the second end, the keypad having a plurality of keys for providing input to the apparatus;
a display screen slidably attached to the housing, the display screen being slidable between a first position covering at least a portion of the plurality of keys and a second position exposing the plurality of keys, the display screen having an outer face; and
a screen-dividing member attached to the housing and covering a portion of the display screen outer face when the display screen is in the first position,
wherein the display screen slides between the screen-dividing member and the housing so as to slide between the first and second positions.

2. The apparatus of claim 1, further comprising:
a processor contained within the housing, the processor configured to display images on the display screen.

3. The apparatus of claim 2, wherein
the processor is configured to display a first image on a first portion of the display screen and a second image on a second portion of the display screen when the display screen is in the first position,
the first portion of the display screen includes a portion of the display screen between a first edge of the screen-dividing member and the housing second end, and
the second portion of the display screen includes a portion of the display screen between a second edge of the screen-dividing member and the housing second end.

4. The apparatus of claim 3, wherein the processor is configured to display a single image occupying substantially the entire display screen when the display screen is in the second position.

5. The apparatus of claim 4, wherein the processor is configured to display the first image on the first portion of the display screen and the second image on the second portion of the display screen by displaying the first image so as to provide information relating to the second image.

6. The apparatus of claim 4, wherein the processor is configured to display the first image on the first portion of the display screen and the second image on the second portion of the display screen by displaying the first image so as to provide selectable options for choosing the second image.

7. The apparatus of claim 2, further comprising at least one user-operable input control on the screen-dividing member, and wherein the processor is configured to receive user input from the control in response to a user interface displayed on the display screen.

8. The apparatus of claim 1, wherein the apparatus is a wireless mobile communication device.

9. The apparatus of claim 1, wherein the display screen covers the entire keypad when in the first position.

10. The apparatus of claim 1, wherein the screen-dividing member is fixedly attached to the housing and positioned such that an edge of the screen-dividing member is adjacent to an outer edge of the keypad when the display screen is in the second position.

11. The apparatus of claim 1, wherein the screen-dividing member is configured to allow viewing of part of the display screen under the screen-dividing member.

12. An apparatus comprising:
a slidable display means for displaying images;
a first input means for interacting with the displayed images when the slidable display means is in a first position and when the slidable display means is in a second position;
a second input means for interacting with the displayed images when the slidable display means is in the second position;
a processing means for processing input from the first input means and the second input means and for presenting images on the display means based on the position of the slidable display means in relation to the first input means; and
a housing means for holding the display means, the first input means, the second input means, and the processing means.

13. The apparatus of claim 12, wherein a plurality of images is displayed when the slidable display means is in the first position and a single image is displayed when the slidable display means is in the second position.

14. An apparatus comprising:
a display screen slidable between a first position and a second position, the display screen having an outer face;
a screen-dividing member covering a portion of the display screen outer face; and
a processor configured to display a first image on a first portion of the display screen and second image on a second portion of the display screen when the display screen is in the first position, and change the display to a single image occupying substantially the entire display screen when the display screen is slid into the second position,
wherein the display screen slides underneath the screen-dividing member when moving between the first position and the second position.

15. The apparatus of claim 14, wherein the first image provides information relating to the second image.

16. The apparatus of claim 14, further comprising at least one input control on the screen-dividing member for providing input to the processor.
